(19) United States
(12) Patent Application Publication
(10) Pub. No.: US 2013/0236878 A1
(43) Pub. Date: Sep. 12, 2013

(54) Method for Testing and Developing Intelligence

(71) Applicant: Alexey Saltanov, San Mateo, CA (US)

(72) Inventor: Alexey Saltanov, San Mateo, CA (US)

(21) Appl. No.: 13/418,266

(22) Filed: Mar. 12, 2012

(51) Int. Cl. G09B 3/00; G06F 15/18

(52) U.S. Cl. 434/353; 706/12

(57) ABSTRACT

The present invention is a method for testing and developing Artificial Intelligence, more particularly intelligence of machines, based on prediction of elements in human-generated documents. Essentially, if Artificial Intelligence can predict elements as effectively as human subjects, it can be considered an intelligent as human beings.

### RELATED APPLICATIONS

None.

### FIELD OF THE INVENTION

The present invention relates to a method for testing and developing Artificial Intelligence, also known as “AI”, and more particularly to an improved method to test, evaluate and provoke learning in AI with or without human interrogators.

### BACKGROUND OF THE INVENTION

What is now commonly known as Turing Test is a test of a machine's ability to exhibit intelligent behavior. The test was introduced by Alan Turing in his 1950 paper “Computing Machinery and Intelligence”. The test is based on questions asked by a human interrogator and responses that arrive via a text-based interface. If the human interrogator cannot distinguish whether the responses came from a human on the other end, or a machine, then the machine was considered to have or display what is known as “artificial intelligence”, or be “artificially intelligent”.

There are several problems with that classic Turing Test. One is that it requires human interrogators, and thus, is not fully automated and is consequently difficult to scale. Another problem is subjectivity akin to humans. Different human interrogators may have very different opinions on whether any particular response came from a human or from a machine. As a result, determining AI is then too slow, too subjective and may even not be possible if some machines are more intelligent than the human interrogator. The Turing test can be used as a measure of a machine's ability to think only if one assumes that an interrogator can determine if a machine is thinking by comparing its behavior with human behavior. Every element of this assumption has been questioned: the reliability of the interrogator's judgement, the value of comparing only behavior and the value of comparing it to a human. Because of these and other considerations, some AI researchers have questioned the usefulness of the classic Turing test. Turing himself did not explicitly state that the Turing test could be used as a measure of intelligence, or of any other human quality. The Turing test was developed to provide a clear and comprehensible alternative to the word “think”, which could then be used to reply to then contemporary criticisms of the possibility of “thinking machines”, and is now used to suggest ways that research might move forward.

A modification, or more accurately, an application of the Turing Test is called CAPTCHA which stands for “Completely Automated Public Turing test to tell Computers and Humans Apart” —is a type of challenge-response test used to distinguish between human and automated responses. The goal is to prevent automated entry onto websites, online databases and other secured locations by “bot”s, i.e. automated computer programs, by presenting a challenge that presumably and hopefully only humans can solve. Although CAPTCHA is often successful for that kind of simple, yes-no decision-making task, it is neither designed for nor capable of measuring actual levels of AI and usually can only measure the ability of recognizing distorted known alpha-numeric or other graphical symbols.

The present invention is a system and method for testing intelligence in humans and machines, viz. AI systems, that is simpler, quantifiable and automated. The present invention is an evaluation method to measure and/or quantify a test objects' level of intelligence, whether they are humans or machines using AI, and to provoke learning and further development of intelligence in the test subjects.

One object of the present invention is to provide a system and method in which participation by human interrogators is not required, thus eliminating at least one subjective factor in evaluating testing objects' intelligence.

Another object of the present invention is to provide a system and method in which testing materials are easily obtained and prepared.

Yet another object of the present invention is to provide an analytical system and method which generates quantitative, objective test results, wherein test initiators can objectively and statistically compare test results among different test objects, different tests and other parameters.

Yet another object of the present invention is to provide a testing method that is completely automated.

Further details, objects and advantages of the present invention will become apparent through the following descriptions, and will be included and incorporated herein.

### BRIEF DESCRIPTION OF THE DRAWINGS

FIG. 1 is a representative flowchart showing essential steps of an embodiment of the system and method of testing, quantifying and developing intelligence of the present invention 100.

FIG. 2 is a representative sample test and scoring of an embodiment 200 of the system and method of testing, quantifying and developing intelligence of the present invention 100.

For a better understanding of the invention, reference is made to the following detailed description of embodiments thereof which should be taken in conjunction with the prior described drawings.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

For a better understanding of the invention, a reference is made to the following detailed description of the preferred embodiments thereof which should be taken in conjunction with the prior described drawings.

Researchers have been using the Turing Test, CAPTCHA and others to distinguish between AI systems and humans for many years. However, the system and method of testing and developing intelligence of the present invention 100 presents a simpler, automated and more quantifiable method for testing intelligence in humans and machines, viz. AI SYSTEMS.

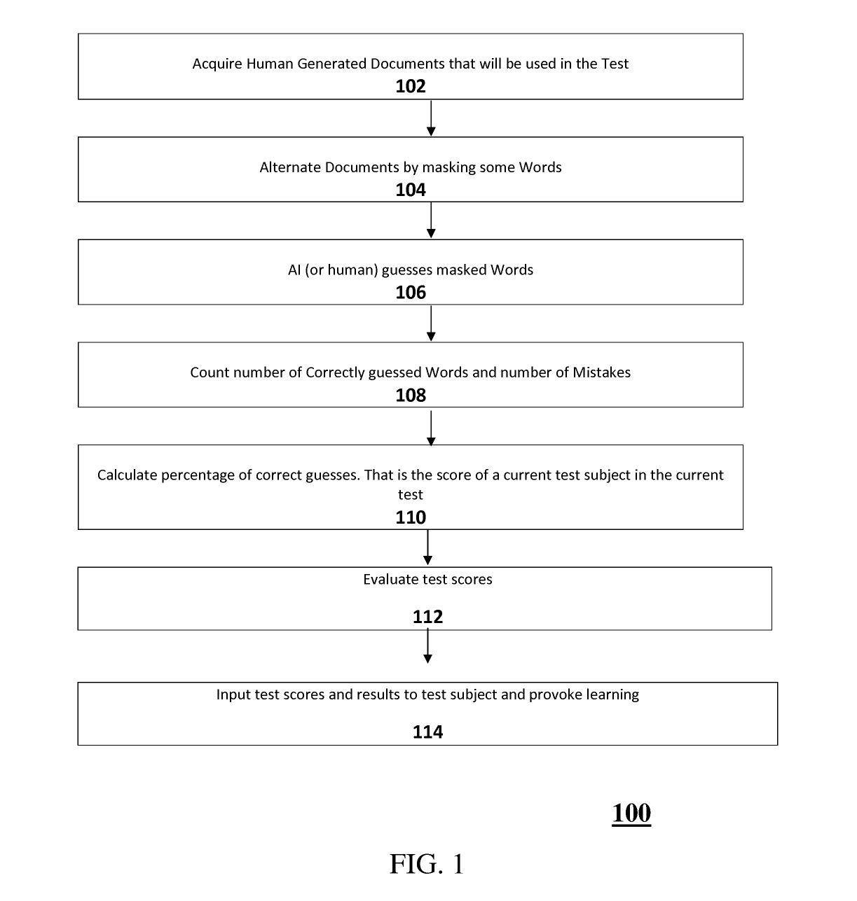

FIG. 1 is a representative flowchart showing essential steps of a system and method of testing, quantifying and developing intelligence of the present invention 100. The present invention 100 uses human-generated documents instead of human interrogators, to test intelligence.

The present invention 100 is a method of testing intelligence of machines and humans with the versatility of comparing test scores amongst AI SYSTEMS, humans and combination thereof. The present invention 100 also allows comparison or ranking amongst different versions of the same AI SYSTEMS based upon the level of intelligence exhibited. The present invention also provides a system and method to test levels of learning or improvement of human subjects by conducting tests sequentially, as in time, after special learning sessions, after illnesses or surgeries, improvements of the human mind or body, and other events that might alter or affect the level of functioning of the human mind.

Step 102:

In Step 102, test initiators acquire human generated test documents that will be used in the test. A typical test document is a predominantly text-based document that was created by humans. Human-generated documents required for the test can be created specifically for such task of serving as test documents, or they can be easily obtained elsewhere, such as from published printed entries in libraries and periodicals, or electronic publications from the World Wide Web. In all cases, most of the documents there are created by humans.

However, according to test objectives and/or subjects, the choice of test documents are not limited to text-only documents. For instance, the test documents can be composed of graphics, pictures, audio files, taste and/or scent samples, tactile response solicitors such as materials or objects of different sizes, shapes, textures, weights, temperature, density, and/or combinations thereof. The objects of selected test documents can be completely random or based on specific subjects of interest or areas of arts or sciences, or grouped otherwise. Thus, intelligence in any of these areas can be tested, i.e., the intelligence of a test subject in a certain field of knowledge can be evaluated and quantified. Such fields might include mathematical, mechanical, industrial, electrical or electronic, materials, chemical and materials science based products, computer hardware, software, interfacing, security, communications, languages, visual arts, performing arts, traditional methods and tools, and other fields.

Step 104:

In general, a set of such test documents are altered, for example, by masking one or more words. Based on the context of the unmasked words visible to the test subject, a human or AI then predicts the masked words. The intelligence of the test subjects is reflected in and quantified by how successfully the test subject is able to predict those masked words in the test documents.

Masking of words can be done in a number of ways. One method of masking is fully random masking. Fully random marking can be achieved by masking every 5^{th} or 10^{th} word or word at other fixed interval throughout the test documents, or by masking a fixed or predetermined number of words at random out of every hundred words, i.e., a certain percentage of the total number of words in the test document selected randomly. Another method is masking all words after, for example, the first hundred words in the test document and asking test subjects to guess sequentially every next word, and either revealing the words serially or simultaneously. Thus, in one type of test, after prediction of the masked word is made by the test subject, the correct word can be revealed and the test subject would continue with predicting the next masked word. Yet another method is to mask specific words (non-randomly) in a document, such as those which the test initiator or interrogator find the most important to guess. The masked words can depend upon the test objectives. Masked words can be words that are deemed to require more intelligence to guess correctly. The masking can also be done in a non-random way where human test initiators choose specific words which best reveal the level of intelligence of the test subject. One of such methods for choosing words or documents is based upon the use of any specific kind of algorithm that is selected that is particularly difficult, easy, interesting, or relevant in some way for the test and test subjects. Yet another method of masking is done when instead of masking the words, certain words in the test documents are altered, alternated, inserted and/or removed, and test subjects are required to restore original order or point where alternations are done.

Step 106:

Test subjects are presented with test documents are requested to complete the task of guessing the mask word or word. One simple example is presented in the following statement:

“Removing the bone from a chicken thigh is more than just a quick and easy process: it is an excellent way to cut down actual cooking time.”

The writing sample was obviously written by a human because it contains subject matter which could only be known through human knowledge. When it is presented to test subjects, the word “time” is masked in that statement and test subjects are asked to guess the masked word. Since the sample statement is simple enough, most human subjects will guess the word correctly. As for AI SYSTEMS, their chance to guess the word correctly depends on the level of their intelligence which is the test objective. Test subjects may or may not be given a definite, predetermined time duration to complete guessing of masked words. They may or may not be given access to their prior responses and thus correct prior mistakes based upon subsequently learned knowledge, and another test is comparison of the two systems for testing learning or acquisition of intelligence.

In one embodiment of the test of the present invention, test subjects are presented with more and more statements or even whole documents with masked words. Test subjects will make their guesses and the number of correct answers will be recorded. In general, the proportion of correct answers to the whole number of guessed words will constitute a test score which, compared with other test subjects, should reveal the relative level of intelligence of the test subject.

Predicting masked words is not an easy task and cannot be done by purely statistical learning algorithms although those will succeed to some extent. Predicting some words requires human-level deduction abilities. Consider this sample statement: “My brother has two brothers and my sister has three sisters. So I have [masked] siblings total.” No statistical learning algorithm could predict masked word unless it was trained on documents that contained that very problem and the identical solution. In this word problem, additional difficulty which can only be solved accurately by a very advanced AI is that in order to solve the problem, it requires determining the gender of the person from who's perspective the story is being told. This affects the number of siblings, i.e., the solution to the problem. A nearly infinite variation of this and other problems and analytical situations can occur in the test documents, which prevents using purely statistical methods to find answers or solutions to masked words. Actual understanding of the nature of problems and human-level deductions is required for an AI to score on par with human subjects.

It is important to distinguish between testing knowledge and testing intelligence. AI SYSTEMS can have virtually unlimited and precise memory that can be equated with “knowledge”, whereas the memory of typical human test subjects is limited and often imprecise. Such differences might permit a particular AI test subject to score better on knowledge of certain facts than a particular human counterpart, while having lower than human intelligence. For example, assume that test initiators choose a set of test documents that contain biographies of thousands of well known people. If during the preparation of the test documents, test initiators non-randomly mask all dates of birth of those people and let human subjects and AI subjects make guesses about those masked dates of birth, the test results will show that AI SYSTEMS score much better than human subjects simply because humans do not typically possess the ability to recall thousands of birthdays from memory, regardless of perhaps their general familiarity or knowledge of the identity of those well known people. AI SYSTEMS may have higher scores as they complete the guesses by accessing their in-memory database. To put humans and machines on the same level might require allowing human subjects access to dictionaries, computers or other sources of precise information, and/or providing a rest time or sustenance duration with facility and food for human test subjects, depending upon the temporal scope, i.e., the duration of or number of test documents in the test. Differences in short tests and longer tests will also reveal quantifiable, objective differences in human and AI subjects.

Step 108 and Step 110:

After running the test and obtaining a set of test results from a test subject, i.e., step 106, the number of correctly guessed masked words is calculated and the number of incorrectly guessed masked words is calculated in Step 108. This is raw data generated directly from the test results. Subsequently, in Step 110, the number of words guessed correctly divided by the total number of masked words is calculated to generate the percentage of correct guesses for each test subject. The percentage of corrected guesses will be the test score of the test subjects whether they are human or AI.

In one embodiment, a correct value [1] is assigned to each correct guess and an incorrect value [0] is assigned to each incorrect guess. In one alternative embodiment, other values such as 10, 50, etc. can be assigned to correct guesses as long as they are consistent throughout the tests and among different test objects when conducting comparison. In another alternative embodiment, different values can be assigned to correct guesses depending on a predetermined difficulty level of masked words. In yet another alternative embodiment, a partial correct value can be assigned to each partial correct guess. The partial correct value is between those of the correct and incorrect guess. A partial correct guess can be synonyms, words of incorrect grammar, tenses, etc.

Step 112:

Once test scores of test subjects are calculated, test initiators can evaluate intelligence level of test subjects, Step 112. Since the test scores are completely quantifiable and are not based on human subjective judgment as in the Turing Test, the test score calculated using human subjects can be compared with scores of AI systems, i.e., the scores of systems utilizing AI for performing tasks or functions. It is also possible to compare scores of different AI SYSTEMS with each other, or different versions of the same AI, in order to compare levels of intelligence. And, because the test is fully automated, it can be duplicated and repeated quickly.

However, it is important to point out that while doing a comparison amongst different machines using different AI systems, they all have potential for virtually unlimited and precise memory, makes them even in some situations. Thus, the differences in scores can be attributed to specific intelligent qualities of machines or systems having AI.

As pointed out above, one of the main differences between the method of the present invention 100 and the classic Turing Test is that in regard to revealing the level of intelligence, the Turing Test only distinguishes between 2 states, i.e., if the level of intelligence exhibited is equivalent to that of a human or not. Anything outside of or other than these two states is very subjective and is dependent upon a human interrogator who, in any event, can only give imprecise, subjective comments. This particular limitation of the Turing Test, therefore, makes it impossible to use for comparison of different test results.

The method of the present invention 100 can determine precise, numerical and comparable levels of intelligence of test subjects. Greater accuracy and less margin of error is achieved using large numbers of test documents and more substantial test documents, in terms of quantity, scope, depth and format, are possible.

Step 114:

Besides testing intelligence, one of the ways this present invention 100 can help develop or increase the level of intelligence exhibited by the subject when it is allowed to learn from its mistakes. Each guess of the test is evaluated and wrong answers are each analyzed individually in order to avoid making a similar mistake in future tests. Test scores of AI test subject are analyzed and learning is provoked in the AI test subject so it will have higher test scores in future tests. with human subject, learning can be achieved or accomplished by showing the test results to the test subjects after scoring has occurred. Showing the test subjects the correct answers to any incorrect answers they originally provided may “teach” the subject. in a similar manner, any AI system can be taught the correct answers to incorrectly guessed masked words. By repeated predicting the same, similar and/or different masked words correctly in a large variety and quantity of human-generated documents, an AI will become very knowledgeable of all aspects of human life, environment, sciences, emotions, human experiences, etc.

To be a good and effective word predictor when given fictional writings, a machine must be able to distinguish between fiction and non-fiction. If a particular AI is trained only on non-fictional test documents, such as for example on science books and encyclopedias, that particular AI will score poorly on test documents created by fiction writers because the difference in learned facts about the real world and facts about imaginary worlds can be quite substantial, regardless of how it is learned. Therefore, if context can be learned, the level of AI can be much greater. Learning context means distinguishing between fact and fiction, real facts or other types of learned facts and ideas.

To be a good and effective word predictor, a machine must also acquire knowledge about emotions. Many human-generated documents contain emotional statements or statements made by humans in a specific emotional state, e.g., sadness, happiness, humorous, etc. To achieve a high score when predicting words in such documents, an AI should understand what effect the emotional state might have on the written statement. If it doesn't, then the score will be below such score achieved by humans that do understand specific emotional states.

Humans are assumed to have consciousness that is reflected in human-generated documents that can be used for testing and developing systems having AI. For example, statements found in human-generated documents as: “I did that”, “I was standing here and then I moved over there”, “I know that I exist”, “There was time when I didn't exist”, and “Next year I'm planning to learn how to swim” all directly and/or indirectly imply human consciousness or an awareness of being. To perform a successful test on such test documents using such test statements, a system having an advanced level of AI should have knowledge about human consciousness, or it will fail in predicting words in such test statements and will result in a lower test scores when compared to test scores of human test subjects. For AI to succeed, it has to either become conscious or become very knowledgeable of what consciousness is and how conscious entities behave, which is part of the learning process. While humans learn this over time, systems using AI can be taught this as well.

An AI which has achieved a score similar to that of a human score in the test that is the subject of the present invention 100 will be able to answer questions on a human level. Any question or interrogatory can be converted to a statement with one or more masked words. For example, the question “How many planets are in the solar system?” can be easily converted to an affirmative statement “In the solar system, there are “X” planets”. Then, the interrogator can ask the system with AI to replace the masked “X” word with the correct word, or in this case number.

In one embodiment, AI or human test subjects will be subjected to the test after performing a learning process such as described in Step 114 of FIG. 1. After each successive test, the test scores are compared to see whether learning has in fact been achieved by the test subjects. Test scores of different versions of the same AI systems can also be compared to see whether the more advanced version is in fact more intelligent. Test scores of AI SYSTEMS that use different algorithms can be compared and AI SYSTEMS with the best scores can be integrated to create more intelligent AI SYSTEMS and improve population of AI systems when genetic algorithms are used.

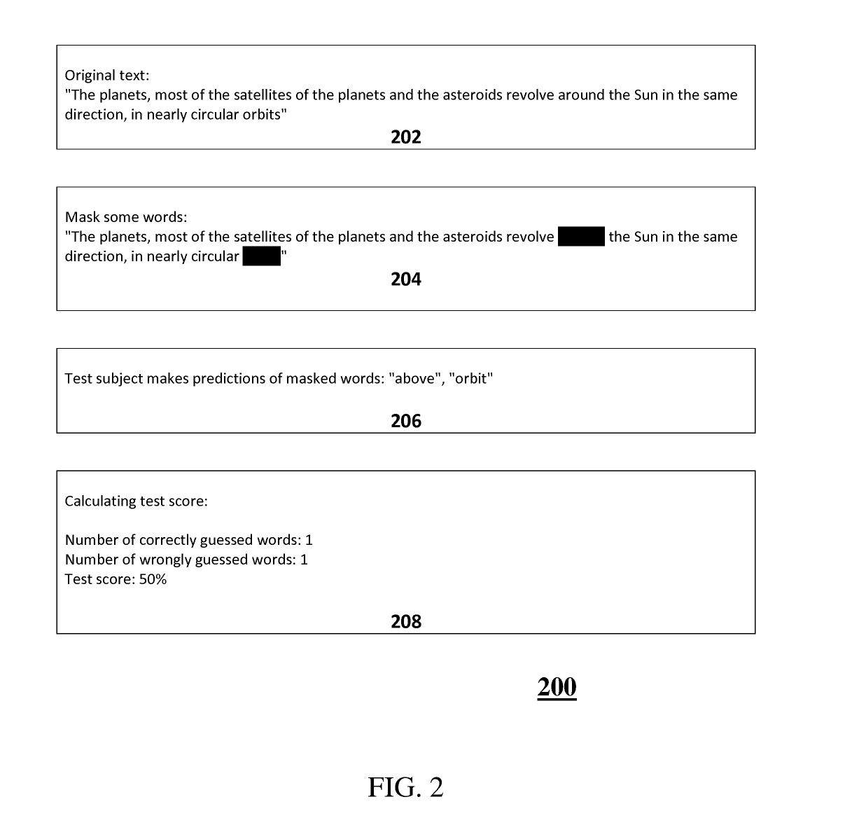

FIG. 2 is a representative sample test and scoring 200 of an embodiment of the system and method of testing, quantifying and developing intelligence of the present invention 100.

In step 202, the original human created test is embodied in the statement which follows: “The planets, most of the satellites of the planets and the asteroids revolve around the Sun in the same direction, in nearly circular orbits.”

In step 204, the words “around” and “orbits” are masked. This is non-random masking, since the words that are masked are words associated with the subject matter of the statement. The statement is then presented to a test subject which is then asked to guess the identity of the masked words.

In step 206, the test subject makes the two guesses to fill in the masked words. It will be understood that these guesses may be correct or incorrect or partially correct.

In step 208, the test score is calculated. In this sample test, a value [1] is assigned to each correct guess and a value [0] is assigned to each incorrect guess. There is no partial score in this test and no predetermined difficulty level of masked words. The test score is only calculated after the test is performed by the test subject. The results of the test are as follows:

Number of correct guess(es): 1

Number of incorrect guess(es): 1

Test score: 1/(2)×100% =50% This is the percentage of correct responses, i.e., the number of correct guesses divided by the total number of questions. In an alternative embodiment, the test score is calculated as the percentage of correct score based upon the total score.

One may argue that AGI, or Artificial General Intelligence, which can exceed human levels of intelligence, is obviously important due to many risks that already threaten human civilization. These include but are not limited to climate change, infectious diseases, and other catastrophic events. AGI can be applied or utilized to solve or avoid these problems. However, machines with AGI possessing artificial consciousness may present on their own an existential risk to humans. It might be considered wise to avoid teaching consciousness to systems with AI and concentrate on using systems with AI to act essentially as ‘smart calculators’ instead of ‘artificial’ or ‘synthetic’ persons. Such smart calculators can answer questions and solve difficult problems without actually being conscious. If an AI system is smart enough to answer how, for example, to avoid the next outbreak of infectious disease or how to build a better solar panel, then the benefit to humans can be achieved without any increased risk of emerging AGI as a threat to humans.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1. A method of testing, evaluating and developing intelligence in a human test subject, the method comprising the steps of:
Showing the human test subject test documents in predetermined topic(s), the test documents further having word(s) masked from the human test subject, the test documents presented to the human test subject in a predetermined sequence;
Requesting the human test subject to take the test by making guesses of the identity of the masked words;
Determining a test score by calculating the percentage of correct guesses by taking the ration of number of correct guesses divided by the total number of guesses;
Requesting the human test subject to repeat tests of a similar level of difficulty on a regular basis, after special learning sessions, after physical and mental improvements achieved, or after any potential intelligence altering experience;
Comparing test scores of all tests by the same human test subject; and
Evaluating results to quantify the subject's increased intelligence.

2. A method of testing, evaluating and developing intelligence of one or more test subjects, the method comprising the steps of:
A. Recruiting one or more test subjects, the test subjects are human beings, artificial intelligence machines or a combination thereof;
B. Creating a test with a predetermined difficulty level by compiling a selection of test documents related to predetermined test topics, the test documents created by humans based upon information in the public domains, the difficulty level of the test at least partly determined by the test topics;
C. Masking one or more words in each test document using predetermined modes of masking, the modes of masking also contribute to the difficulty level of the test;
D. Presenting the masked test documents to the one or more test subjects in a predetermined sequence;
E. Instructing the one or more test subjects to make one guess for the identity of each masked word until all masked words has been provided with an answer;
F. Comparing the one or more test subjects' guessed answers for each masked word with the real word, assigning a correct score to each correctly guessed answer and an incorrect score to each incorrectly guessed answer, a total correct score being calculated by adding the number of correctly guessed answers; and
G. Calculating a percentage test score for each of the one or more test subjects by taking the ration of the number of correctly guessed answers with the total number of questions in the test document.

3. The method of evaluating and developing intelligence in the one or more test subjects of claim 2 in which the correct score is 1, 10, 100, or any real number.

4. The method of evaluating and developing intelligence in the one or more test subjects of claim 2 in which the incorrect score is 0 or any real number less than the correct score.

5. The method of evaluating and developing intelligence in the one or more test subjects of claim 3 in which the correct score further assigned different values depending on a predetermined difficulty level of each corresponding masked word.

6. The method of evaluating and developing intelligence in the one or more test subjects of claim 2, further comprising the following step:
H. Assigning a partial score for each narrowly missed guessed answer, value of the partial score between the correct score and the incorrect score.

7. The method of evaluating and developing intelligence in the one or more test subjects of claim 6 in which the narrowly missed guess answer is synonym of the corresponding masked word.

8. The method of evaluating and developing intelligence in the one or more test subjects of claim 2, further comprising the following step:
I. Permitting the one or more test subjects to evaluate each guess and the test scores of the one or more test subjects and teaching the one or more test subjects to repeat similar correct guesses and avoid similar incorrect guesses in future tests.

9. The method of testing, evaluating and developing intelligence in the one or more test subjects of claim 2 in which the test documents are in the form of text, graphic, picture, audio, video, tactile, smell and a combination thereof.

10. The method of testing, evaluating and developing intelligence in the one or more test subjects of claim 2 in which the one or more test subjects are human, artificial intelligence machine or a combination thereof.

11. The method of evaluating and developing intelligence in the one or more test subjects of claim 2, further comprising the following step:
J. Comparing the test scores between one or more human test subjects and one or more artificial intelligence machine test subjects.

12. The method of testing, evaluating and developing intelligence in the one or more test subjects of claim 2 in which masking is performed in a random mode.

13. The method of testing, evaluating and developing intelligence in the one or more test subjects of claim 2 in which masking is performed in a non-random mode.

14. The method of claim 12 in which a predetermined percentage of words in the test documents are masked randomly.

15. The method of claim 13 in which every n-th word is masked, where n is equal to a predetermined number.

16. The method of testing, evaluating and developing intelligence in the one or more test subjects of claim 2 in which the mode of masking is non-random, predetermined word(s) are masked according to the test objectives.

17. The method of testing, evaluating and developing intelligence in the one or more test subjects of claim 2 in which the mode of masking is sequential, most words in the test documents are masked and then revealed to the one or more test subjects in groups.

18. The method of testing, evaluating and developing intelligence in the one or more test subjects of claim 2 in which the mode of masking is sequential, most words in the test documents are masked and then revealed to the one or more test subjects individually.

19. The method of testing, evaluating and developing intelligence in the one or more test subjects of claim 2 in which the test topics are science, human interests, social events, human emotions, social science and combinations thereof.

20. The method of evaluating and developing intelligence in the one or more test subjects of claim 2 further comprising the following steps:
K. Instructing the one or more test subjects to repeat the test with the similar difficulty level;
L. Comparing the test scores of the same one or more test subjects of different tests and recording improvement and regression of the one or more test subjects; and
M. Comparing the test scores of different test subjects of the same test; and
N. Drawing conclusions, the conclusions include but not limited to whether the one or more test subjects possess intelligence comparable to intelligence of human beings.

21. The method of evaluating and developing intelligence in one or more test subjects of claim 2, further comprising the following steps:
O. Selecting one or more artificial intelligence machine test subjects having the highest test scores;
P. Integrating algorithms of the one or more selected artificial intelligence machine test subjects, and administering the test to one or more integrated artificial intelligence test subjects; and
Q. Comparing the test scores of the one or more original artificial intelligence machine test subjects and the one or more integrated artificial intelligence test subjects to see whether improvement has been achieved.
